(19) United States
(12) Patent Application Publication
(10) Pub. No.: US 2008/0062337 A1
(43) Pub. Date: Mar. 13, 2008

(54) REMOTE CONTROL

(75) Inventor: Ferdinand Maier, Obertrum am See (AT)

Correspondence Address: SENNIGER POWERS LLP, ONE METROPOLITAN SQUARE, 16TH FLOOR, ST LOUIS, MO, 63102, US

(73) Assignee: fm marketing gmbh, Obertrum am See (AT)

(21) Appl. No.: 11/851,132

(22) Filed: Sep. 6, 2007

(30) Foreign Application Priority Data
Sep. 7, 2006 (DE) 102006042014.4

(51) Int. Cl. H04N 5/44

(52) U.S. Cl. 348/734; 348/E05.096

(57) ABSTRACT

The customizable remote control for control of interactive multimedia devices, especially a set-top box (15), has a first hardware device, especially a fingerprint reader (15), by means of which authorized persons can be unambiguously identified. Moreover, the remote control has a second hardware device, preferably a SIM card reader (16a), for the unambiguous identification of the remote control (12). This ensures that only authorized remote controls (12) can communicate with and control the set-top box (5) and also that new entry or changes of user data of authorized persons can only be done with the second device, especially a SIM card (16).

### FIELD OF THE INVENTION

The invention concerns a customizable remote control and a combination of such a remote control with a set-top box for the operation of multimedia home electronics.

### BACKGROUND OF THE INVENTION

A remote control for operation of multimedia home electronics is known from WO 02/17627 A2. There, a remote control for a set-top box is described that can be customized to the particular user, which can be done by physical attributes of the particular user, e.g., a fingerprint reader, a voice recognition circuit, an iris scanning device, a “sniffing [odor detection] device,” a facial recognition device. As an alternative to the customization, the particular user can also be asked to enter a password, a definite series of keystrokes or the like. In this way, for example, a set-top box and other home entertainment equipment such as video recorder, CD player, DVD player, etc., can be controlled with a single remote control within a family or household.

A customization of a remote control in connection with a set-top box has a number of benefits:
The set-top box can be programmed for child protection, in that only selected television channels can be viewed or other television channels can be blocked;
the set-top box can be programmed so that the viewing habits of each user, especially their preferred television channels, are assembled into preprogrammed groups, e.g., sports channels, entertainment channels, educational channels, etc.;
according to the user, certain times can be set up when the particular user is allowed to use certain devices;
the key assignments of the individual keys of the remote control can be changed according to the user, so that the number of possible keys can also be reduced;
the user can be identified in interactive systems, such as interactive television, home shopping, home banking, video on demand, or the like, and additional safety features can also be built into the set-top box in this case, for example, limit amounts for orders of goods or films, types of films (e.g., G-rated), etc.

In the remote control described in WO 02/17627 A2, the user is identified once, via the fingerprint reader, for example. The remote control then remains customized for this user until he signs off by pressing a particular key. If he forgets to do so, another user can perform the functions of the prior user with full access authorization. As a remedy for this, it can be provided that the customization and thus most of the functions of the remote control are automatically switched off if no key of the remote control is activated in a particular period of time or if the set-top box or a television set is switched off. It can also be provided that any key stroke can be executed only when the fingerprint reader has also identified a person at the same time. Another possibility is to provide that all or at least several keys of the remote control are outfitted with a fingerprint reader.

But another problem with this known remote control is how the remote control is initially programmed for the particular user, i.e., how the individual user is identified for the first time. If a new and as yet unidentified user signs on, for example, by pressing his thumb against the fingerprint reader, the known remote control offers a menu to establish a new user, who can then reserve to himself all access rights, which are then saved in the remote control and/or the set-top box.

Another problem is that a remote control of the above-described kind, once programmed, can be used without difficulty to also operate “foreign” set-top boxes, at least if they are of the same design as one's “own” set-top box or, which is often the case, use the same signal encoding. Thus, it is possible to perform functions such as internet banking, ordering of goods, etc., with a connection to a foreign set-top box.

WO 02/084991 A2 likewise describes a remote control customized to the particular user for an interactive TV system. Primarily, this involves a key assignment customized to the particular user, in order to reduce the number of keys. Additional functions, such as “open garage door,” can be implemented. A table can be saved for several users, in which the assignment of individual keys to certain functions can be established for specific users. By pressing a particular key, a menu can be called up in which all users are listed and can be selected. No safety measures of any kind are provided here, such as to prevent someone from signing in under a user name not assigned to him.

U.S. Pat. No. 5,861,881 describes an interactive computer system for multimedia operation, in which a user profile can be saved. This can occur both in a local computer or a host computer of a network. This computer system can also be connected, for example, by cable to television transmitters. Certain data or video content can be selected via this stored user profile.

U.S. Pat. No. 5,715,020 describes a remote control which can control a plurality of devices. Each remote control has a code identifying it uniquely. A central control unit for several remote controls can thereby identify the individual remote control and assign certain remotely controlled devices to it.

The problem of the invention is to improve the remote control of the kind mentioned at the outset such that a high degree of access security is guaranteed. This means, on the one hand, that unauthorized persons cannot operate the remote control or even reprogram it, and on the other hand that a device being used with the remote control, such as a set-top box, can only be operated with an authorized remote control, but not with an unauthorized remote control.

### SUMMARY OF THE INVENTION

Briefly, therefore, the invention is directed to a customizable remote control for control of interactive multimedia devices, with a first hardware device for recognition of persons, characterized by a second interchangeable hardware device for unambiguous identification of the remote control.

The invention is also directed to a combination of customized remote control and interactive multimedia device, wherein a data exchange between the remote control and the device is only possible when the remote control has identified itself to the device by means of a hardware device for unambiguous identification of the remote control.

The invention is further directed to a customizable remote control assembly for control of a media appliance, the remote control assembly comprising a remote control having a person identifier for recognizing a person; a remote control identifier associated with the media appliance for recognizing the remote control; and a data carrier for holding data associated with the remote control for recognition by the remote control identifier; wherein the person identifier and remote control identifier cooperate to ensure that the media appliance is controllable only by said remote control and not by other remote controls, and to ensure that only authorized persons operate said remote control.

Advantageous embodiments and modifications of the invention will be found in the subclaims, and are otherwise described explicitly or implicitly herein.

### BRIEF DESCRIPTION OF THE DRAWINGS

The invention is explained in further detail in the following by means of an embodiment in connection with the drawings:

FIG. 1, a schematic diagram of a multimedia network with a remote control according to the invention;

FIG. 2, a more detailed schematic diagram of a remote control to actuate a set-top box according to one embodiment of the invention.

### DETAILED DESCRIPTION OF PREFERRED EMBODIMENTS

This application claims priority from German patent application 10 2006 042 014.4, the entire disclosure of which is expressly incorporated by reference.

The basic principle of the invention consists in a first hardware feature for recognition of persons, that is, for identifying authorized persons to the remote control, and in identifying the remote control to a remote control identifier, such as a set-top box, associated with the media device being controlled, by an interchangeable hardware feature. The first hardware feature is a person identifier, which is a mechanism which can identify a person, and in the preferred embodiment shown here, for example, is in particular a device for reading and recognition of a human fingerprint. The second hardware feature in the preferred embodiment is a data carrier, which is shown here as at least one SIM card in the remote control. In addition, yet another SIM card can also be provided in the device being controlled. An effective remote controlling or remote attendance is only possible when both hardware features—the device for recognizing persons and the device for identifying the remote control to the device being controlled—cumulatively grant access authorization. In other words, only a remote control outfitted with the appropriate SIM card can establish a communications link with a remote control identifier associated with the media device, which here is shown as a set-top box, and also it can only do even this if the fingerprint reader has recognized an authorized person.

It is also provided that a programming of another user, with reading in of his fingerprint, is possible only when the corresponding SIM card is present.

The device identification for the first time can take place such that it is only possible with SIM card inserted. For future access, the corresponding access data of the SIM card can be stored in a memory of the remote control, so that access later on does not require the SIM card, but only the identification of authorized users via the fingerprint reader.

Later changes to the access authorizations of authorized users or the adding of further authorized users are only possible with the SIM card inserted.

SIM (Subscriber Identity Module) cards are usually chip cards which are inserted into a mobile telephone and serve to identify the user in the network. They have been used in the millions, are obtainable at a reasonable price, and are still considered to be extremely secure and reliable means of encryption. What is more, SIM cards also have the benefit that data can be stored on them, and thus presettings can be transmitted to other devices, for example, when one device is faulty.

Another feature to enhance the security can be that the identification code or codes between remote control and set-top box are changed during each activation, in the sense of a code incrementing, as is described in DE 35 18 827. The disclosure content of this publication is hereby included by reference. Also, it is in this way no longer possible, for example, to use a reading device to read out all codes of one remote control and transfer them to another remote control. Such reading devices or learning remote controls are commercially available today as replacements for defective remote controls, and are described, for example, in the U.S. Pat. Nos. 4,626,848 and 4,623,887.

After a modification of the invention, the remote control also has additional communication possibilities, such as a microphone, a camera and/or a USB port for acoustic and visual communication of the subscribers within a network, as well as for data exchange.

In general, it should be further noted that the term “remote control” in the sense of the present specification not only includes the traditional remote controls for home electronics, such as television sets, video recorders, set-top boxes, etc., but also devices with expanded functions, such as an alphanumeric keyboard and other input/output devices for mostly wireless transmission of signals to other devices, with the limitation that these are controlled. In the sense of the present invention, there is primarily a bidirectional communication between the remote control and the remotely controlled device, although a bidirectional communication between the controlled device, such as a set-top box, and a remote station, such as a provider, can also take place. Thus, the remote control can also contain further components, such as a computer mouse, a so-called joystick, a so-called track ball, a so-called touchpad or a so-called touch screen, and all of these latter-mentioned devices are input devices in the broadest sense of the word, producing control codes for a device being controlled.

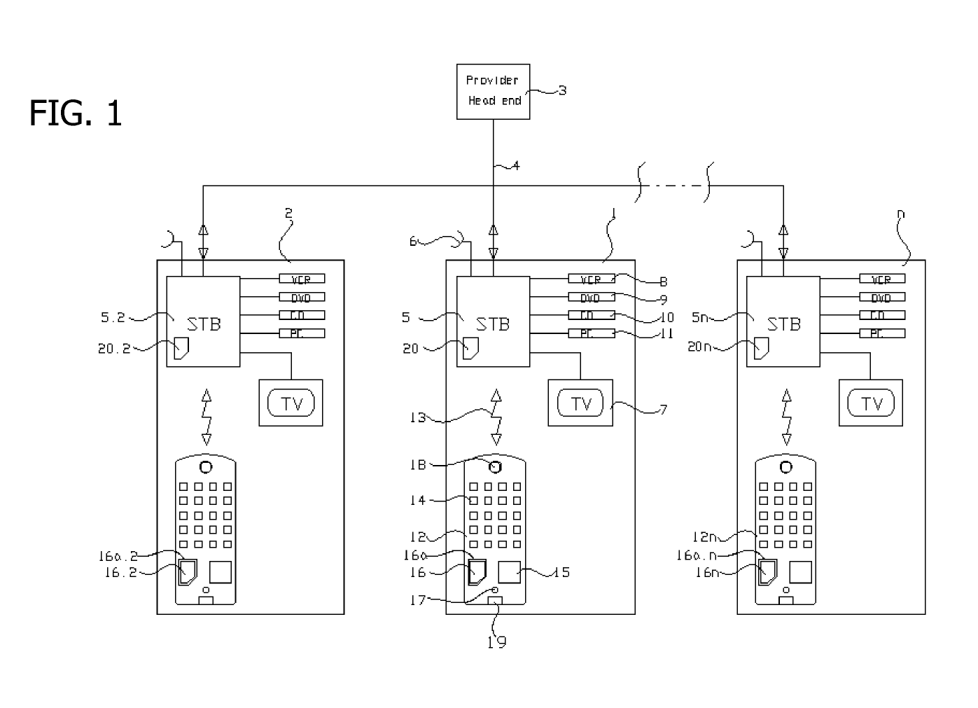

The network shown in FIG. 1 has several stations 1, 2, to n, which are connected to a remotely situated base station 3. This can also involve, for example, a television transmitter, an internet service provider, or other providers purveying suitable information for the multimedia sector, which in modern devices occurs via a return channel 4 that can be, for example, a telephone line, a DSL connection, or a radio link such as UMTS [universal mobile telecommunications system], which is connected to a so-called set-top box 5 that usually also has additional inputs, such as for input from an antenna 6.

The functions of the set-top boxes are being constantly expanded with the aim of constructing a universal multimedia communication and information center.

As a rule, at least one television receiver 7 is connected to a set-top box 5, basically having only the function of a monitor for the visual display of the information provided by the set-top box. Most of the information, such as channel selection, loudness, etc., is controlled via the set-top box 5. In addition, further peripherals such as a video recorder 8, a DVD player 9, a CD player 10 or even a personal computer 11 can be connected to the set-top box 5 or to the television set 7.

All functions of the set-top box, and for the most part, also all other functions of the devices 7-11 connected to it, are controlled via a remote control 12, which as a rule communicates with the set-top box 5 via a wireless link 13, such as an infrared link or a radio link. All common methods of wireless information transmission are possible here, such as the Bluetooth protocol. Of course, a wireline connection via an electrical cable is also possible.

The remote control 12 usually has a keypad 14 with a number of keys, which when activated relay predetermined signals to the set-top box 5 or its peripherals 7-11. The functions assigned to the individual keys of the key pad 14 are programmable such that different functions can be assigned to the individual keys for the different users, and thus the remote control 12 is “customizable.” Various possibilities as to how this customization can be done have been described in the prior art discussed at the outset. From this, and from the other prior art, the practitioner is aware of many options for the hardware and software implementation, so that details need not be given here.

One preferred mechanism for this customization in the present invention is a fingerprint reader 15 integrated in the remote control 12. Such fingerprint readers are commercially available and are being used with success in various fields, for example, in personal computers, access controls to protected rooms, etc. The essential function of the fingerprint reader 15 consists in reading the fingerprint, for example, that of the thumb of a user, ascertaining certain identification features from that and transforming them into identification data which are compared with previously stored identification data. Thus, a user can be identified with a given degree of agreement between the presently read and the stored identification data. After such an identification, various functions of the remote control 12 can be called up, such as key assignment of the functions of the individual keys of the key pad 14, or blocking or access authorizations for certain functions or programs of the set-top box 5. It is also possible to activate the send function of the remote control 12 via this customization.

However, certain problems arise in the configuration described heretofore, which are solved with the present invention.

In the known remote controls, the reading in of a new user or also the changing of the access authorization and the user profile of an already detected user is effected simply by calling up a given menu item, which is possible by pressing a key. Some security against establishing a new user or changes to an already authorized user is afforded, however, in that a password has to be entered to call up these functions, which usually consists of a four-place digit sequence. It will be very hard to keep this password secret within a household or a family, and it is also easy to “crack” with a little skill and a certain amount of time, so that the child protection function is already inadequate. In particular, juveniles will try to defeat this protection. Another problem is that the set-top box of one station, such as station 1, can also be controlled with other remote controls, such as with the remote control 12n of station n, or the set-top box 5n of station n with the remote control 12 of station 1. This is at least easily possible when a remote control is available for the same type of set-top box.

Also, many programmable remote controls are on the market today which are adaptable to practically all commercially available set-top boxes, so that it is no problem to replace a remote control protected by fingerprint reader with another one and thereby gain access to all functions of a set-top box, including pay for view broadcasts, ordering of goods or even internet banking. The particular set-top box is as a rule identified to the provider 3 by the return channel 4 or by other known security measures in the set-top box, while the transmission route 13 is largely unprotected.

To solve this problem, the remote control 12 of the invention has an additional hardware feature, which is preferably realized by a SIM card reader 16a and a SIM card 16. Each remote control has an individual SIM card, to which various functions can be assigned alternatively or cumulatively, such as
The particular remote control 12 identifies itself to its set-top box 5 via the code of the SIM card. The set-top box can be programmed so that it accepts only commands from a remote control which contains an individual SIM card 16.
The remote control 12 is configured so that it only sends out control commands by key stroke when the SIM card 16 is inserted.
The remote control 12 is configured such that input of a new user or changes of user profiles involving the fingerprint reader 15 are only possible when the SIM card 16 is inserted into the SIM card reader 16a. It can also be provided that an identification code of the SIM card 16 is stored in the remote control 12, so that after this storing the remote control 12 can also be identified to the set-top box 5 without the SIM card 16 inserted into the SIM card reader 16a. In other words, after input of one or more users, the SIM card 16 can be removed and kept in a safe place, while all the above defined security requirements are still fulfilled, since neither a “foreign” remote control can connect to the set-top box nor are changes possible to the users or the user profiles with one's “own” remote control.

The particular remote control 12 thus identifies itself in conjunction with the SIM card 16 to a single assigned set-top box 5, while the individual user identifies himself via the fingerprint reader 15.

In order to organize the initialization phase, i.e., the first making of a connection between remote control 12 and set-top box 5, in both a flexible and a secure fashion, it can be provided that the set-top box also has a reader 20 for a SIM card. During the initialization, the SIM card 16 can be inserted into the reader 20, thereby storing the identification code in the set-top box 5. After this, the same SIM card 16 can be removed from the reader 20 and inserted into the SIM card reader 16a of the remote control 12 to accomplish its programming or customization. Of course, it is also possible to use two SIM cards matched up with each other, namely, one for the reader 20 of the set-top box 5 and the other for the SIM card reader 16a of the remote control 12.

Moreover, it can be provided that many functions which demand heightened security, such as paid orders for goods or services, access to bank accounts, etc., are only possible when the SIM card 16 is inserted in the SIM card reader 16a of the remote control 12.

To expand the functions of the remote control, it can also contain a microphone 17, by which voice-control commands are relayed to the set-top box and by which an acoustic communication is also possible in the manner of a telephone call via the set-top box and the return channel 4. The sound reproduction can then occur via the loudspeaker of the television set. In addition, it would also be possible to effect a voice recognition of the individual user in conjunction with the microphone 17.

Moreover, the remote control 12 has a video camera 18 by means of which images are recorded, in order to relay them via the set-top box to other set-top boxes, where the images are displayed on the television set.

Finally, the remote control 12 also has a USB interface 19 for connection to a personal computer or for coupling to other peripherals, such as a game console or the like. Via this USB interface 19, the remote control 12 can also be programmed from a PC, and here as well all security-relevant functions remain intact thanks to the SIM card 16.

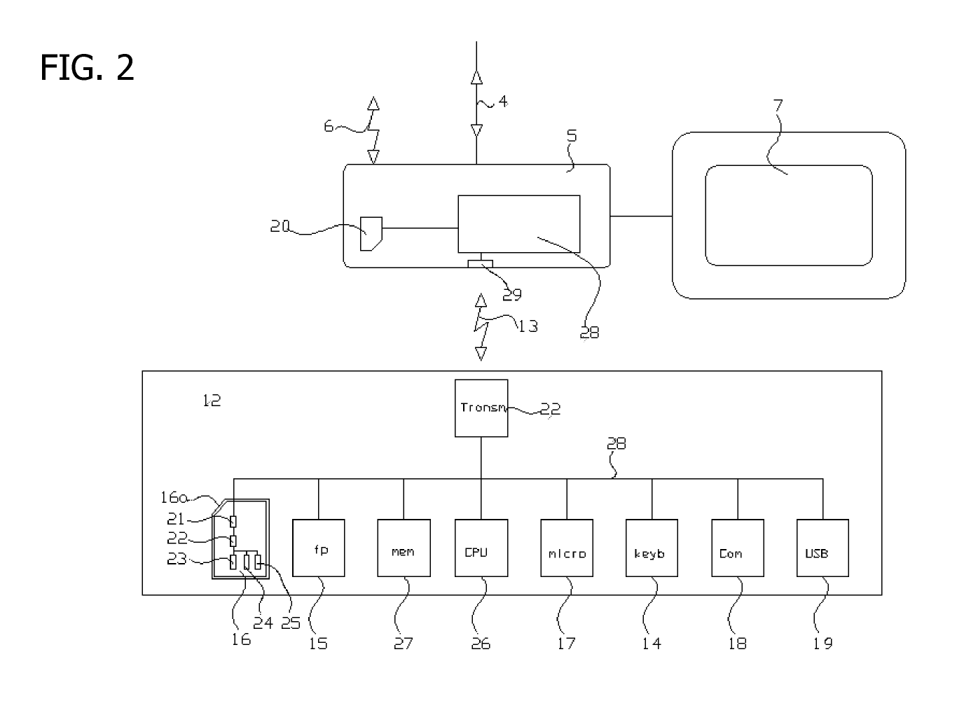

FIG. 2 shows a schematic diagram of the remote control 12 and a set-top box 5, wherein only the essential functional elements are portrayed. The remote control 12 contains the SIM card 16 or, more precisely, a receptacle for a SIM card, i.e. the SIM card reader 16a, with the usual contacts. This SIM card itself has an input/output unit 21, a processor 22, a read-only memory 23 (ROM), a random access memory 24 (RAM) and another memory 25 in the form of an EEPROM. Moreover, the remote control contains the fingerprint reader 15, the microphone 17, the video camera 18, the USB port 19 and the keypad 14, while all these mentioned elements are connected, for example, via a BUS line 28, to a processor 26. Moreover, the remote control 12 contains another memory 27, and finally, a sending and receiving unit 22 that sends out and receives signals wirelessly over the link 13.

The memory 27 contains on the one hand the operating system as well as all necessary data, such as assignment tables, user code, memorized data of the fingerprint reader 15, user profiles, etc., even including the identification data of the SIM card 16, insofar as this is implemented according to the above explained embodiment.

The SIM card 16 can also save various data. Thus, for example, its operating system resides in the ROM 23. The volatile data required at the moment are kept in the RAM 24, while user data are kept in the EEPROM 25. The EEPROM 25 can be a mirror of part of the memory 27, in order to transmit certain user data to another remote control.

In this embodiment, the set-top box 1 in similar fashion also has a SIM card reader 20 which is connected to the rest of the electronics 28. Of course, this also has in familiar manner a central unit, at least one memory, and various interfaces for peripherals such as the television receiver 7, as well as a sending and receiving unit 29 that can exchange data bidirectionally with the sending and receiving unit 22 via the link 13.

Of course, the set-top box and/or the remote control can be configured and in particular programmed so that all usual functions and also the expanded functions of home networks are implemented.

When introducing elements of the present invention or the preferred embodiment(s) thereof, the articles “a”, “an”, “the” and “said” are intended to mean that there are one or more of the elements. For example, that the foregoing description and following claims refer to “an” interconnect means that there are one or more such interconnects. The terms “comprising”, “including” and “having” are intended to be inclusive and mean that there may be additional elements other than the listed elements.

As various changes could be made in the above without departing from the scope of the invention, it is intended that all matter contained in the above description and shown in the accompanying drawings shall be interpreted as illustrative and not in a limiting sense. The scope of invention is defined by the appended claims and modifications to the embodiments above may be made that do not depart from the scope of the invention.

1. A customizable remote control for control of interactive multimedia devices, with a first hardware device for recognition of persons, characterized by a second interchangeable hardware device for unambiguous identification of the remote control.

2. The remote control of claim 1 wherein the second hardware device is a SIM card.

3. The remote control of claim 1:
wherein the first hardware device and the second hardware device are interconnected so that new input and/or changes in regard to the first hardware device are only possible in presence of the interchangeable second hardware device.

4. The remote control of claim 2:
wherein the first hardware device and the second hardware device are interconnected so that new input and/or changes in regard to the first hardware device are only possible in presence of the interchangeable second hardware device.

5. A combination of customized remote control and interactive multimedia device, wherein
a data exchange between the remote control and the device is only possible when the remote control has identified itself to the device by means of a hardware device for unambiguous identification of the remote control.

6. The combination of claim 5 wherein the remote control and the device each have a device for reading of unambiguous identification data in the form of a SIM card.

7. A customizable remote control assembly for control of a media appliance, the remote control assembly comprising:
a remote control having a person identifier for recognizing a person;
a remote control identifier associated with the media appliance for recognizing the remote control; and
a data carrier for holding data associated with the remote control for recognition by the remote control identifier;
wherein the person identifier and remote control identifier cooperate to ensure that the media appliance is controllable only by said remote control and not by other remote controls, and to ensure that only authorized persons operate said remote control.

8. The customizable remote control assembly of claim 7 wherein the person identifier recognizes the person by means of a characteristic unique to the person.

9. The customizable remote control assembly of claim 8 wherein said characteristic unique to the person is selected from characteristics consisting of fingerprint, voice, iris, odor, and face.

10. The customizable remote control assembly of claim 7 wherein the person identifier recognizes the person by means of a password.

11. The customizable remote control assembly of claim 7 wherein the person identifier is a fingerprint reader.

12. The customizable remote control assembly of claim 7 wherein the data carrier carries data which identifies the remote control to the remote control identifier.

13. The customizable remote control assembly of claim 7 wherein the data carrier is interchangeable between the remote control and the remote control identifier.

14. The customizable remote control assembly of claim 7 wherein the data carrier is a SIM card.

15. The customizable remote control assembly of claim 7 wherein the remote control identifier is a set-top box.

16. The customizable remote control assembly of claim 7 wherein the data carrier communicates data to the remote control identifier during an initialization operation to establish recognition of the remote control.

17. The customizable remote control assembly of claim 7, wherein:
the person identifier for recognizing a person is a fingerprint reader;
the remote control identifier associated with the media appliance is a set-top box; and
the data carrier for holding data input via the remote control for recognition by the remote control identifier is a SIM card.

18. The customizable remote control assembly of claim 7, wherein the data carrier for holding data associated with the remote control for recognition by the remote control identifier is a first SIM card, and the assembly further comprises a second SIM card for the remote control identifier, which second SIM card is matched with the first SIM card.
